(19) United States
(12) Patent Application Publication
(10) Pub. No.: US 2026/0324540 A1
(43) Pub. Date: Oct. 22, 2026

(54) AGRICULTURAL MATERIAL EJECTION APPARATUS

(71) Applicant: Kubota Corporation, Osaka (JP)

(72) Inventor: Masaru TORIMOTO, Sakai-shi (JP)

(21) Appl. No.: 19/696,907

(22) Filed: Jun. 3, 2026

Related U.S. Application Data
(63) Continuation of application No. PCT/JP2023/046942, filed on Dec. 27, 2023.

(51) Int. Cl. A01C 7/04; B64U 10/14; B64U 101/40

(52) U.S. Cl. CPC A01C 7/042; B64U 10/14; B64U 2101/40

(57) ABSTRACT

An agricultural material ejection apparatus configured to be suspended and supported by an aircraft and to supply a granular agricultural material to a supply target location includes a storage configured to store agricultural material, a feeder configured to feed the agricultural material stored in the storage, and an ejection mechanism configured to eject the agricultural material fed by the feeder from an ejection outlet to the supply target location. The ejection mechanism includes a gas compressor configured to compress a gas, a gas passage through which the compressed gas is passable from the gas compressor toward the ejection outlet, and a temporary holder to temporarily hold the agricultural material from the feeder at an intermediate portion of a path of the gas passage and allow the agricultural material to be ejected toward the supply target location by the compressed gas.

### CROSS REFERENCE TO RELATED APPLICATIONS

This application is a Continuation Application of PCT Application No. PCT/JP2023/046942 filed on Dec. 27, 2023. The entire contents of this application are hereby incorporated herein by reference.

### BACKGROUND OF THE INVENTION

### 1. Field of the Invention

The present invention relates to agricultural material ejection apparatuses configured to be suspended and supported by an aircraft and to supply a granular agricultural material such as seed or fertilizer to a supply target location.

### 2. Description of the Related Art

Conventionally, as an example of an agricultural material ejection apparatus, there has been a seeding machine configured as follows.

The seeding machine includes a tank that stores seed as an example of an agricultural material, a feed mechanism that feeds the seed from the lower side of the tank, a shooter unit that drives the fed seed in a field, and a cylindrical guide body extending in an up-down direction that guides the seed fed by the feed mechanism to the shooter unit. The shooter unit includes a rotating body having a plurality of blades, which extend radially and are driven to rotate at high speed, and is configured to eject the seed that is fed from the feed mechanism and falls downward through the interior of the guide body, downward using the blades of the rotating body (e.g., see WO2021/182108).

### SUMMARY OF THE INVENTION

In the above conventional configuration, the agricultural material needs to be forcefully ejected downward by blades, and therefore the rotating body needs to be driven to rotate at high speed. However, since the agricultural material falls freely toward the rotating body rotating at high speed, the agricultural material does not necessarily enter an upstream side of the blades in the rotation direction. For example, the agricultural material may be caught and jammed between a leading end portion of a blade and an inner surface of the cylindrical guide body. In such a state, there is concern that the blades may press the agricultural material against the inner surface of the guide body with great force, causing the agricultural material to be crushed, or causing clogging due to the agricultural material being caught, for example.

In view of this, there has been a demand for an agricultural material ejection apparatus that is capable of forcefully ejecting an agricultural material but does not cause problems such as crushing or clogging of the agricultural material, and that is capable of supplying the agricultural material to a supply target location in a favorable manner.

An agricultural material ejection apparatus according to an example embodiment of the present invention is configured to be suspended and supported by an aircraft and to supply a granular agricultural material to a supply target location and includes a storage configured to store the agricultural material, a feeder configured to feed the agricultural material stored in the storage, and an ejection mechanism configured to eject the agricultural material fed by the feeder from an ejection outlet to the supply target location, the ejection mechanism including a gas compressor configured to compress a gas, a gas passage through which the compressed gas is passable from the gas compressor toward the ejection outlet, and a temporary holder capable of temporarily holding the agricultural material at an intermediate portion of a path of the gas passage, the temporary holder including a cylindrical container including an inner passage portion through which the agricultural material is passable, a plurality of holders provided at different positions in a circumferential direction outward of the passage portion of the container, the plurality of holders being capable of moving back and forth along directions in which the holders approach and move away from the passage portion, and biasing elements movably biasing the plurality of holders toward waiting positions at which the holders enter the passage portion, wherein the agricultural material fed from the feed section is capable of being received and temporarily held while the plurality of holders are at the waiting positions, and in response to the compressed gas acting to push the agricultural material, the plurality of holders move in directions away from the passage portion against a biasing force of the biasing elements to allow the agricultural material to be ejected toward the supply target location.

A gas such as air is compressed by the gas compressor, the gas compressed by the gas compressor is guided through the gas passage to the ejection outlet and is then ejected from the ejection outlet toward a supply target location such as a field. A plurality of holding members are provided at intermediate portions of the path of the gas passage. The holders are located at waiting positions due to the biasing force of the biasing elements and capable of temporarily holding the agricultural material fed from the feed section. In response to the compressed gas supplied through the gas passage acting on the agricultural material temporarily held by the holders, the agricultural material is pushed to move the holders in a direction away from the passage portion against the biasing force of the biasing elements, and the agricultural material is ejected toward the supply target location.

With this configuration, the compressed gas efficiently acts on the temporarily held agricultural material, and the agricultural material can be ejected forcefully. In addition, only the compressed gas acts on the agricultural material, and the agricultural material does not collide with objects moving at high speed, nor is the agricultural material caught between the objects.

Accordingly, it has become possible to forcefully eject the agricultural material but does not cause problems such as crushing or clogging of the agricultural material, and to eject the agricultural material to a supply target location in a favorable manner.

In an example embodiment of the present invention, the holders are located at portions spaced approximately 120 degrees apart from each other along the circumferential direction, for example.

According to this configuration, the holders are arranged at equal or substantially equal intervals to allow the agricultural material to be temporarily held in a favorable manner.

In an example embodiment of the present invention, the holders are spherical, and the biasing elements are coil springs.

According to this configuration, the holders can be suitably moved using the elasticity of the coil springs. Further, since the holders are spherical, the agricultural material can be prevented from being damaged due to contact with the holders.

In an example embodiment of the present invention, preferably, the gas compressor includes a cylinder tube, a piston configured to slide within the cylinder tube, a gas supply and discharge capable of switching between a supply state in which the gas is supplied into an internal space of the cylinder tube and a release state in which the internal space is opened to an outside, and a discharger configured to discharge the gas supplied into the internal space and compressed, to the gas passage from the cylinder tube in accordance with movement of the piston.

According to this configuration, upon a gas being supplied to the internal space of the cylinder tube by the gas supply and discharge while the piston is stopped, the gas is compressed in the internal space. Then, the compressed gas is discharged toward the gas passage through the discharger in response to the piston moving with the gas compressed in the internal space. With this configuration, a simple configuration can be adopted in which the gas is ejected toward the gas passage by compressing the gas and moving the piston.

In an example embodiment of the present invention, preferably, the agricultural material ejection apparatus further includes a first gas chamber located on a first side of the piston in a sliding direction thereof inside the cylinder tube, and a second gas chamber located on a second side of the piston in the sliding direction inside the cylinder tube, and a rod extending along the sliding direction on the first side of the piston in the sliding direction, wherein the discharger is provided at an end portion of the cylinder tube on the first side in the sliding direction, the rod is switchable between a closed state in which the rod closes the discharger and an open state in which the rod opens the discharger to allow the gas to be discharged, in accordance with movement of the piston, in response to the gas supply and discharge being switched to the supply state, the rod enters the closed state, and the gas is supplied to the first gas chamber and the second gas chamber and is compressed, and in response to the gas supply and discharge being switched to the release state, the rod switches to the open state, and the gas compressed in the first gas chamber is discharged from the discharger to an outside of the cylinder tube.

According to this configuration, in response to the gas supply and discharge being switched to the supply state, the rod enters the closed state, and the gas is supplied to the first gas chamber and the second gas chamber and compressed. Thereafter, in response to the gas supply and discharge being switched to the release state, the rod enters the open state, and the gas compressed in the first gas chamber is discharged from the discharger. With this configuration, the configuration of the ejection mechanism can be simplified by effectively using the rod provided in the piston.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a front view illustrating a work system according to an example embodiment of the present invention.

FIG. 2 is a plan view illustrating a work system according to an example embodiment of the present invention.

FIG. 3 is a longitudinal side view of a seeding apparatus.

FIG. 4 is a longitudinal cross-sectional view of an ejection mechanism.

FIGS. 5A to 5E are explanatory views illustrating operation of the ejection mechanism.

FIG. 6 is a plan view of a temporary holder.

FIG. 7 is a perspective view of the temporary holder in an attached state.

FIGS. 8A to 8C are plan views of the temporary holder according to another example embodiment of the present invention.

FIG. 9 is a plan view of the temporary holder according to another example embodiment of the present invention.

FIG. 10 is a perspective view of the temporary holder according to another example embodiment in an attached state.

### DETAILED DESCRIPTION OF THE EXAMPLE EMBODIMENTS

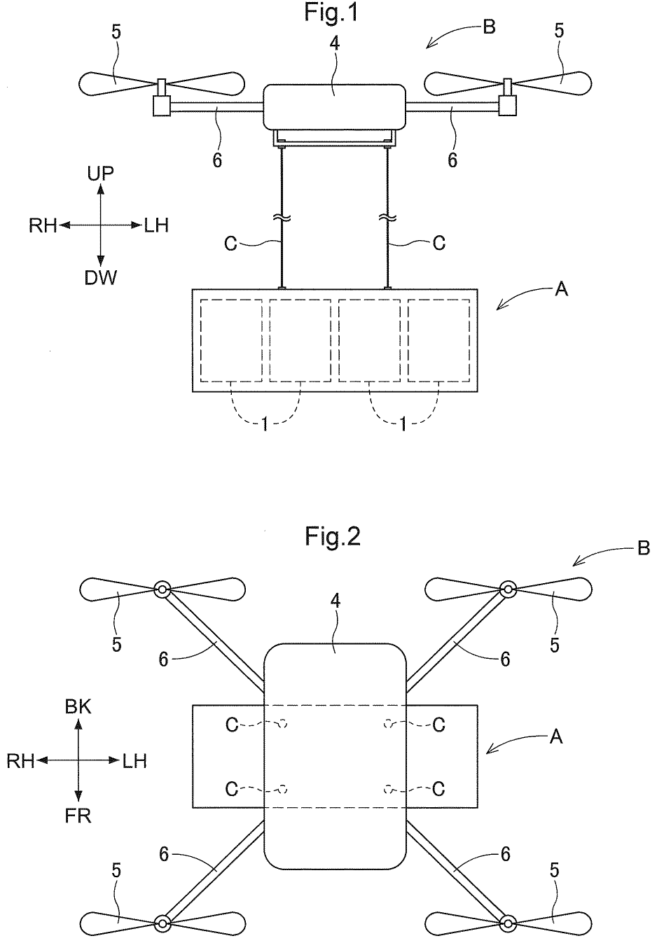

Example embodiments of the present invention will be described below with reference to the drawings. Note that, unless otherwise stated in the following description, the term “front” refers to the direction indicated by arrow FR in FIG. 2, the term “rear” refers to the direction indicated by arrow BK, the term “left” refers to the direction indicated by arrow LH in FIGS. 1 and 2, and the term “right” refers to the direction indicated by arrow RH. The term “upper/above” refers to the direction indicated by arrow UP in FIG. 1, and the term “lower/below” refers to the direction indicated by arrow DW.

FIGS. 1 and 2 illustrate a work system for supplying an agricultural material to a field. The work system includes a work device A that includes a plurality of seeding apparatuses 1, each of which is as an example of an agricultural material ejection apparatus according to an example embodiment of the present invention, an unmanned aircraft B referred to as a drone, and a plurality of connection bodies C for the aircraft B to suspend and support the work device A. The aircraft B is capable of flying independently. The aircraft B includes a main body 4, a plurality of propellers 5, and a plurality of arms 6.

Although the number of propellers 5 and arms 6 is not particularly limited, four propellers 5 and four arms 6 are provided in the present example embodiment. The four arms 6 extend from the main body 4 toward front-left, front-right, rear-left, and rear-right directions, respectively.

Each propeller 5 is driven by driving force of an electric motor (not shown). The aircraft B is capable of flying by driving each propeller 5. That is, by driving the propellers 5, the aircraft B is capable of moving in the up-down direction, the front-back direction, and the left-right direction while floating in the air. The aircraft B is also capable of hovering flight by driving the propellers 5.

Each seeding apparatus 1 is suspended and supported by the main body 4 via a plurality of connection bodies C (e.g., wires). A plurality of seeding apparatuses 1 are arranged side by side at intervals in the left-right direction and integrally combined to provide the work device 2. Although a case of using four connection bodies C is illustrated as an example, the number thereof is not limited to four and may be changed as appropriate.

The seeding apparatus 1 ejects seed, which is an example of an agricultural material, whereby the seed can be driven into and supplied to a field. Although not described in detail, the flight state of the aircraft B is managed such that the seeding apparatus 1 moves along a path along which seeding is to be performed. Here, the aircraft B may repeat movement operation and position-stopping operation, and may perform seeding work during the position-stopping operation. Alternatively, seeding work may be performed while continuously moving by the aircraft B.

Although not illustrated, the aircraft B includes a satellite positioning device having a known configuration, and a flight controller configured or programmed to drive and control the propellers 5 to control the movement state of the aircraft B. The satellite positioning device receives GNSS (Global Navigation Satellite System) signals from artificial satellites and generates positioning data indicating a position of the aircraft B based on the received signals. As the GNSS, GPS, QZSS, Galileo, GLONASS, BeiDou, or the like can be used. The flight controller is configured or programmed to drive and control the propellers 5 based on measurement results of the satellite positioning device and preset field map data such that the aircraft B moves along a predetermined work path.

Next, a configuration of the seeding apparatus 1 will be described.

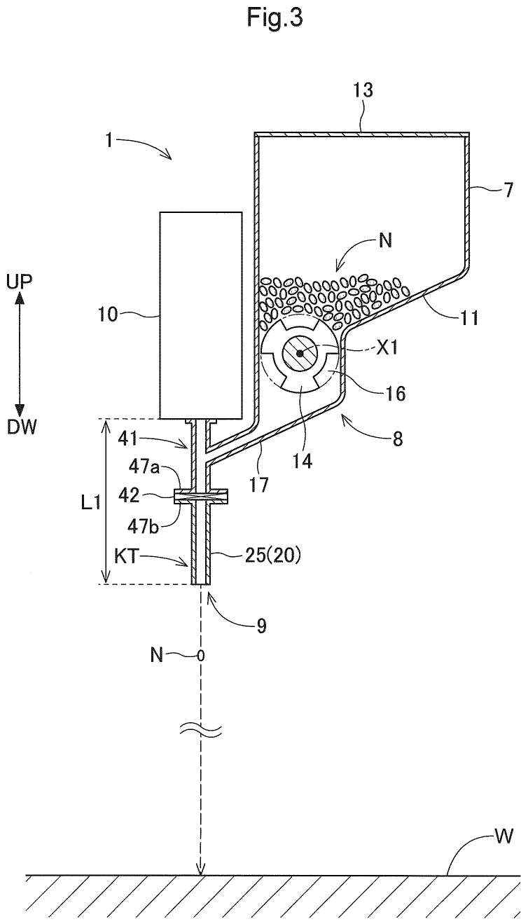

As illustrated in FIG. 3, the seeding apparatus 1 includes a hopper 7 serving as a storage for storing seed, a feeder 8 that feeds the seed stored in the hopper 7, and an ejection mechanism 10 that ejects the seed fed by the feeder 8 from an ejection outlet 9 toward a field W serving as a supply target location.

The hopper 7 includes a storage space surrounded by side walls. An opening is located at an upper portion of the storage space, through which a large amount of seed N can be loaded. After the seed N is loaded, the opening is closed by a lid 13 that is attachable and detachable. A flow guide 11 including a tapered shape narrowing toward the lower side is provided at a lower portion of the hopper 7. The seed N can be discharged downward from a lower portion of the flow guide 11. A feed roller 14 is provided at a discharging location.

The feed roller 14 is rotatably supported about an axis X1 extending in the left-right direction. Recesses 16 into which the seed N can enter are located in an outer peripheral portion of the feed roller 14. A plurality of recesses 16 are located at predetermined intervals in the circumferential direction. The feed roller 14 has a narrow width in the rotation axis direction such that one or several seeds N can enter each recess 16. The feed roller 14 is driven to rotate about the axis X1 by an electric motor (not shown).

As the feed roller 14 rotates, the seed N received in the recesses 16 is discharged downward. A cylindrical supply 17 that guides the seed N discharged from the feed roller 14 is provided at a lower portion of the hopper 7.

The ejection mechanism 10 is provided on a lateral side of the feeder 8. The seed N fed from the feeder 8 is ejected by the ejection mechanism 10 and forcefully supplied toward the field W.

The ejection mechanism 10 in the present example embodiment of the present disclosure includes a gas compressor 18 that compresses a gas, and a gas guide 20 that extends from the gas compressor 18 and includes an ejection outlet 9 at its leading end, and that guides the gas compressed by the gas compressor 18 to the ejection outlet 9 while maintaining the pressure of the gas, and ejects the seed N from the ejection outlet 9 toward the field W.

The gas compressor 18 includes a cylinder tube 21, a piston 22 that slides within the cylinder tube 21, a gas supply and discharge 23, and a discharger 24. The gas supply and discharge 23 is switchable between a supply state in which the gas is supplied into the internal space of the cylinder tube 21 and a release state in which the internal space is opened to the outside. The discharger 24 discharges the gas supplied into the internal space and compressed to the outside of the cylinder tube 21 in accordance with movement of the piston 22.

The gas guide 20 is provided in communication with the discharger 24 and includes a cylindrical guide 25. The guide 25 has an inner diameter that is smaller than an inner diameter of the cylinder tube 21 and that allows passage of the seed N.

The ejection mechanism 10 will now be described in more detail.

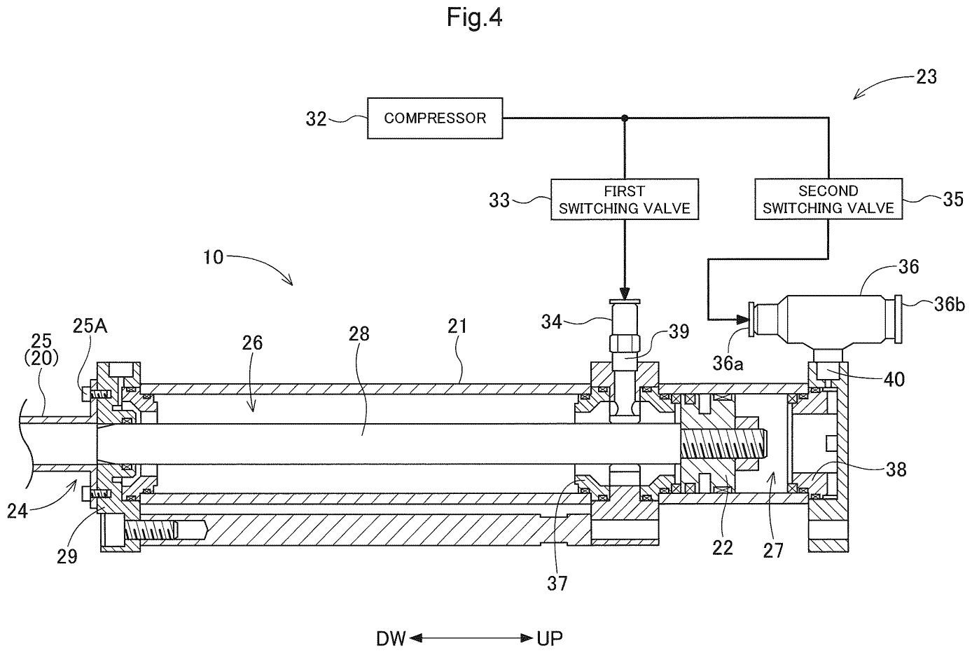

As shown in FIG. 4, the ejection mechanism 10 includes the cylinder tube 21 and the piston 22 that slides within the cylinder tube 21. A first gas chamber 26 and a second gas chamber 27 are provided as internal spaces inside the cylinder tube 21. The first gas chamber 26 is located on a first side of the piston 22 in the sliding direction. The second gas chamber 27 is located on a second side of the piston 22 in the sliding direction.

A rod 28 extending in the sliding direction is provided on the first side of the piston 22 in the sliding direction. The discharger 24 is provided at an end portion on the first side of the cylinder tube 21 in the sliding direction. The discharger 24 includes an opening extending through one sealing block body 29 along the sliding direction. An end portion of the rod 28 on the first side in the sliding direction can be inserted into the opening of the discharger 24.

The discharger 24 is closed (as in the state illustrated in FIG. 4) upon the end portion of the rod 28 on the first side in the sliding direction being inserted into the opening of the discharger 24. Upon the rod 28 sliding toward the second side in the sliding direction, the rod 28 is withdrawn from the opening and the discharger 24 is opened. That is, the rod 28 is switchable between a closed state in which the rod 28 closes the discharger 24 and an open state in which the rod 28 opens the discharger 24 to allow gas ejection, in accordance with movement of the piston 22.

The gas supply and discharge 23 is switchable between a supply state in which gas is supplied into the first gas chamber 26 and the second gas chamber 27 of the cylinder tube 21 and a release state in which the first gas chamber 26 and the second gas chamber 27 are opened to the outside.

As shown in FIG. 4, the gas supply and discharge 23 includes a compressor 32 defining and functioning as a gas supply source, a first switching valve 33, a check valve 34, a second switching valve 35, and a quick exhaust valve 36.

The first switching valve 33 is switchable between a supply state in which the gas is output from the compressor 32 to the first gas chamber 26 and a stop state in which the output is stopped. The second switching valve 35 is switchable between a supply state in which the gas is output from the compressor 32 to the second gas chamber 27 and a stop state in which the output is stopped. In response to the second switching valve 35 being switched to the supply state, the quick exhaust valve 36 allows the gas to be supplied into the second gas chamber 27. In response to the second switching valve 35 being switched to the stop state, the quick exhaust valve 36 is switched to a state of rapidly opening the second gas chamber 27 to the outside while blocking a reverse flow toward the second switching valve 35 with the check valve 34.

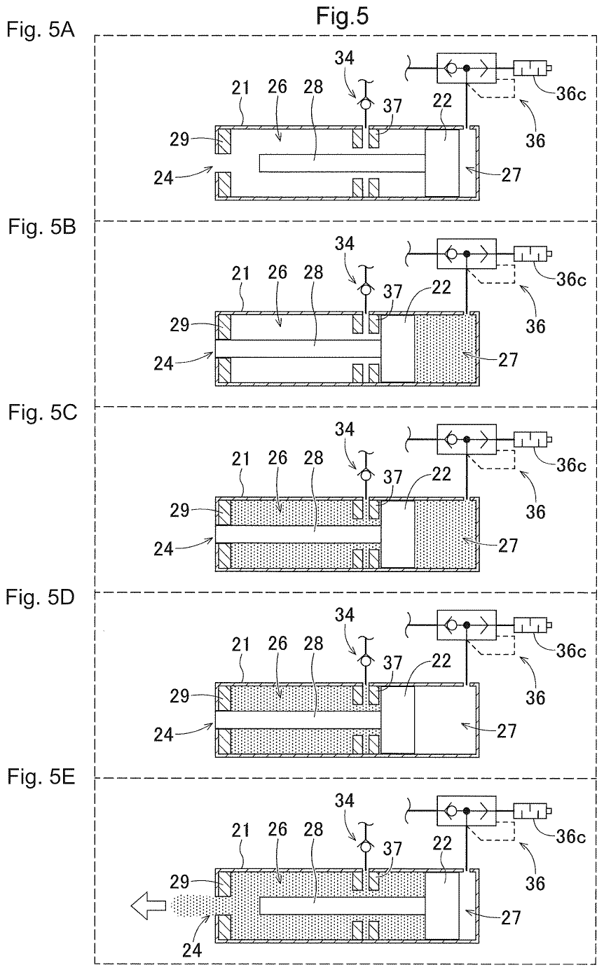

The quick exhaust valve 36 has a well-known configuration, and has an inlet 36a to which the gas is supplied from the second switching valve 35 and a discharger 36b to which the gas inside the second gas chamber 27 is discharged. The quick exhaust valve 36 also includes a silencer 36c (see FIGS. 5A to 5E) that reduces or prevents discharge noise while the gas inside the second gas chamber 27 is discharged.

The gas supply and discharge 23 is capable of supplying the gas to the first gas chamber 26 and the second gas chamber 27 while the rod 28 is in a closed state. In response to the gas being supplied into the first gas chamber 26 and the second gas chamber 27, the gas is compressed in each of the first gas chamber 26 and the second gas chamber 27, in which the internal pressure increases. At this time, the rod 28 is maintained in the closed state due to a difference in the area of pressure acting surfaces of the piston 22. Thereafter, in response to the gas supply and discharge 23 being switched from the supply state to the release state, the compressed gas in the second gas chamber 27 is released, switching the rod 28 to an open state and discharging the compressed gas from the discharger 24.

A central sealing block body 37 is provided at an intermediate portion of the cylinder tube 21 in the sliding direction. The central sealing block body 37 is hollow to allow the rod 28 to be inserted. The piston 22 is slidable between the central sealing block body 37 and another sealing block body 38.

The cylinder tube 21 includes a first air supply 39 and a second air supply 40. The first air supply 39 receives the gas supplied from the first switching valve 33. The second air supply 40 receives the gas supplied from the second switching valve 35 via the quick exhaust valve 36. The first air supply 39 is provided on the central sealing block body 37. The second air supply 40 is provided on the other sealing block body 38.

As shown in FIGS. 3 and 4, a guide 25 included in the gas guide 20 is provided outward of the first side of the cylinder tube 21 in the sliding direction. The guide 25 is connected in communication with the opening of the discharger 24. The gas discharged from the discharger 24 is discharged downward through the guide 25.

In response to the rod 28 being switched to the open state with the gas compressed in the internal space of the cylinder tube 21, the gas in the internal space is guided to the ejection outlet 9 through the interior of the guide 25 while maintaining high pressure without abruptly expanding at the discharger 24. The seed N can be forcefully ejected downward by the gas passing through the interior of the guide 25.

The guide 25 is mounted to the discharger 24 of the cylinder tube 21 in an attachable and detachable manner. As shown in FIG. 4, a flange portion 25A is provided on an outer peripheral portion of an upper end portion of the guide 25, and this flange portion 25A is bolted to an end portion of the cylinder tube 21. The guide 25 can be removed from the cylinder tube 21 by releasing the bolt joint. The ejection speed when the seed N is ejected from the ejection outlet 9 can be changed by changing the guide length of the guide 25 or changing the pressure of the gas generated by the compressor 32.

The supply 17 is connected in communication with an intermediate portion of the guide 25 in the up-down direction. The seed N fed from the feeder 8 through the supply 17 is supplied into the interior of the guide 25. The supplied seed N is ejected toward the field W by the gas forcefully ejected from the discharger 24.

The guide 25 functions as a gas passage KT through which the compressed gas passes from the gas compressor 18 toward the ejection outlet 9. A temporary holder 42 capable of temporarily holding the seed N is provided at an intermediate portion of the path of the gas passage KT. The temporary holder 42 is capable of temporarily holding the seed N fed from the feeder 8, and allows the seed N to be ejected toward the field W serving as the supply target location, using the compressed gas.

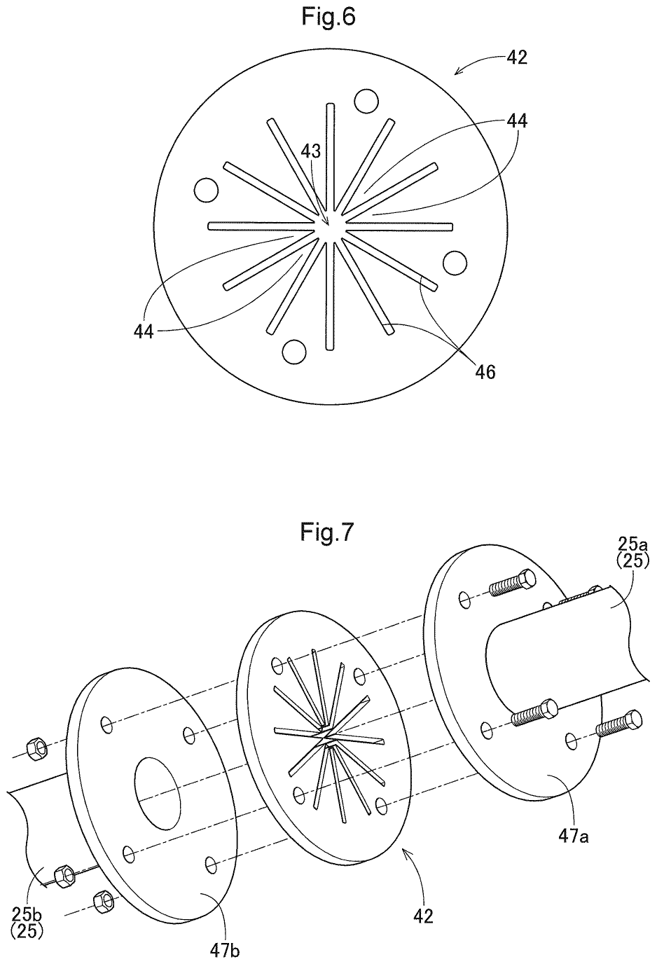

As shown in FIGS. 6 and 7, the temporary holder 42 is made of a circular plate-shaped soft material such as rubber, has a holding force that allows it to receive the seed N, and includes a passage 43 through which the seed N can pass in response to the action of the pressing force applied by the compressed gas. The passage 43 is surrounded by arms 44 each including a widening shape with a width that increases towards the outer side, and the arms 44 are arranged side by side in its circumferential direction. The plurality of arms 44 are continuously connected on the outer circumference side and are each cantilevered shape so as to be elastically deformable on the passage 43 side.

In other words, the temporary holder 42 includes an insertion hole 45 at a center portion of a circular rubber plate, with a diameter smaller than that of the seed N. A plurality of cutouts 46 are provided, each extending radially from the insertion hole 45 to an intermediate portion in the radial direction, and the plurality of arms 44 include a plurality of regions sandwiched between the cutouts 46. A configuration in which the insertion hole 45 is not provided may alternatively be used as a configuration in which the arms 44 extend to a center portion.

As shown in FIGS. 3 and 7, the temporary holder 42 has a larger diameter than the guide 25 and is sandwiched between upper and lower holding plates 47a and 47b. The guide 25 is divided into upper and lower portions at its intermediate portion, with the upper holding plate 47a integrally joined to an outer circumferential portion of a lower end portion of an upper guide 25a, and the lower holding plate 47b integrally joined to an outer circumferential portion of an upper end portion of a lower guide 25b. With the temporary holder 42 sandwiched by the upper holding plate 47a and the lower holding plate 47b, the upper holding plate 47a and the lower holding plate 47b are fastened and fixed to each other by a plurality of bolts.

By providing such a temporary holder 42 at an intermediate portion of the path, the seed N fed from the feeder 8 is temporarily received and held by this temporary holder 42. Thereafter, upon the compressed gas being ejected from the gas compressor 18, the pressure of the ejected gas deforms the arms 44 of the temporary holder 42, and the seed N is forcefully ejected towards the field W.

Next, operations of the ejection mechanism 10 will now be described.

In a standby state illustrated in FIG. 5A, both the first gas chamber 26 and the second gas chamber 27 are in an open state. In response to the second switching valve 35 being switched to the supply state, the gas is supplied into the second gas chamber 27 of the cylinder tube 21 through the second air supply 40.

As illustrated in FIG. 5B, in response to the gas being supplied into the second gas chamber 27, the piston 22 slides toward the first side in the sliding direction, and the rod 28 is switched to the closed state in which the discharger 24 is closed.

As illustrated in FIG. 5C, in response to a supply of the gas to the first gas chamber 26 being started while the supply of the gas to the second gas chamber 27 is continued, the internal pressure in the first gas chamber 26 and the second gas chamber 27 increases due to compression of the gas. This state corresponds to the supply state of the gas supply and discharge 23. At this time, the rod 28 is maintained in the closed state. That is, since the area of the pressure acting surface of the piston 22 on the second gas chamber 27 side is greater than the area of the pressure acting surface of the piston 22 on the first gas chamber 26 side, the piston 22 is pushed toward the first gas chamber 26, and the rod 28 is maintained in the closed state.

As illustrated in FIG. 5D, in response to the first switching valve 33 being switched to the stop state, the compressed gas stored in the second gas chamber 27 is discharged to the outside through the quick exhaust valve 36.

As illustrated in FIG. 5E, as the internal pressure in the second gas chamber 27 decreases, the piston 22 moves toward the second side in the sliding direction (toward the second gas chamber 27) due to a pressure difference between the first gas chamber 26 and the second gas chamber 27, and the rod 28 enters the open state. This operation corresponds to the gas supply and discharge 23 being switched to the release state.

As a result, the discharger 24 is opened, and the compressed gas retained in the first gas chamber 26 is forcefully discharged from the discharger 24. The gas forcefully discharged from the discharger 24 is then guided to the ejection outlet 9 via the guide 25, and the seed N fed from the feeder 8 is ejected toward the field W.

The temporary holder 42 may be configured as follows.

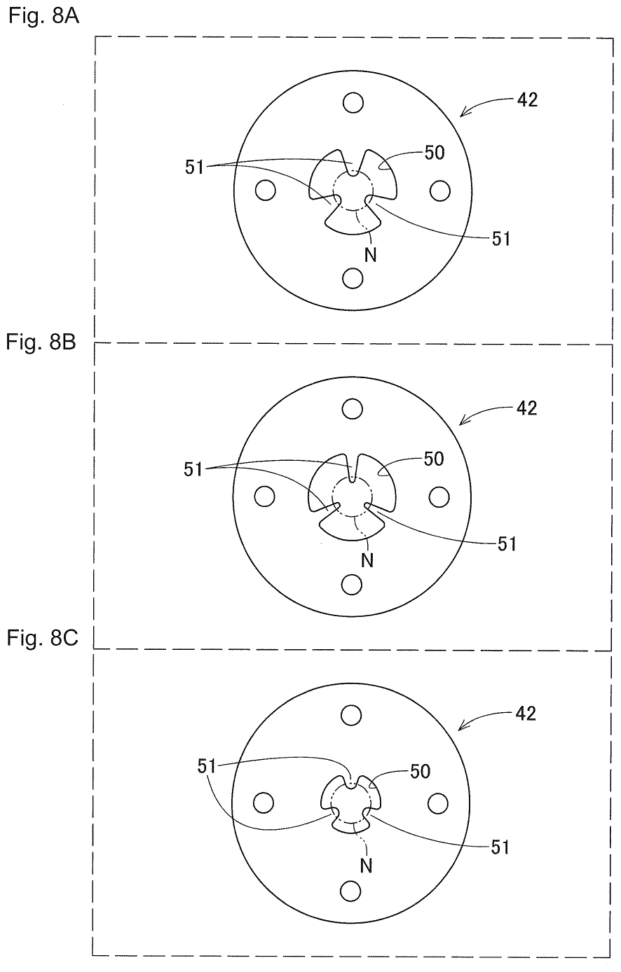

While the temporary holder 42 has a holding force that allows it to receive the seed N (agricultural material) as in the above example embodiment, the passage may be configured as follows. That is, as shown in FIGS. 8A to 8C, a substantially circular insertion hole 50 with a diameter larger than that of the agricultural material is located at a center portion of a disk-shaped rubber plate. Protrusions 51 that protrude inward in the radial direction are integrally formed at portions spaced approximately 120 degrees, for example, from each other in the circumferential direction on an inner circumferential portion of the insertion hole 50. An imaginary circle passing through leading ends of the protrusions 51 is smaller than the outer shape of the seed N. In this configuration, the seed N is received and supported by three protrusions 51. Further, as shown in FIGS. 8A, 8B, and 8C, the width of each protrusion 51 may be changed, and the inner diameter of the insertion hole 50 may be changed.

The temporary holder 42 may be configured as follows.

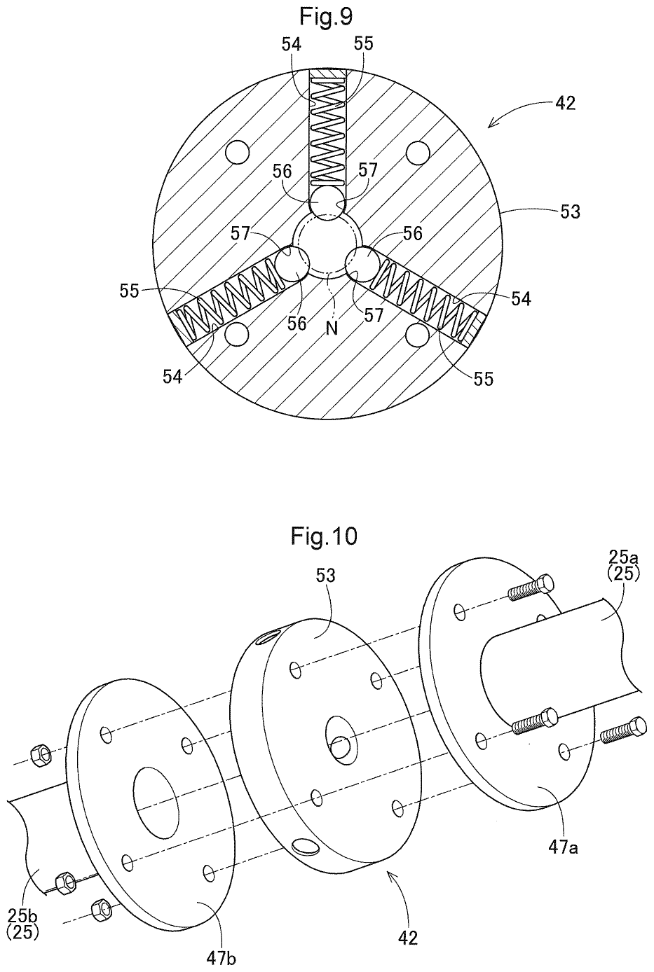

Instead of providing a plate-shaped soft material, as shown in FIG. 9, a cylindrical container 53 through which the seed N can pass is provided, and three through holes 54 extending along the radial direction are located at portions spaced approximately 120 degrees from each other in the circumferential direction inside the container 53. A spherical holder 56, which is movable in the radial direction and is biased to move inward in the radial direction by a coil spring 55, is provided in each insertion hole 54. The three holders 56 are received by respective locking portions 57 at positions protruding a predetermined amount inward in the radial direction from an inner circumferential surface of the container 53, and are held at these positions. The temporary holder 42 is held and sandwiched between the upper holding plate 47a and the lower holding plate 47b, as in the above example embodiment. According to this configuration, upon the seed N being supplied, the seed N is received and held by the three holders 56. The biasing force of the coil springs 55 that bias the holders 56 is set such that the holders 56 have a holding force that allows them to receive the seed N, and such that the seed N can pass in response to the action of the pressing force applied by the compressed gas.

A guide 25 having a fixed guide length may be fixed to the cylinder tube 21. In this case, the ejection speed when the seed N is ejected from the ejection outlet 9 may be changed by changing the pressure of the gas generated by the compressor 32.

The aircraft B may be of a drive type in which the propellers are driven by an internal combustion engine, or a parallel hybrid drive type in which the propellers are driven using an electric motor and an internal combustion engine. Alternatively, a series hybrid drive type may be adopted in which a generator is driven by an internal combustion engine and an electric motor is driven by generated electric power. The aircraft B is not limited to an unmanned flight configuration, and may be configured to fly while being piloted by a person.

As a gas supply source, the following configuration may be adopted instead of the compressor 32.

For example, a configuration may be adopted in which a liquid substance having a property of being easily vaporized is stored in a tank, and gas that is generated by vaporization of the liquid from an internal space of the tank and forcefully expands from a discharger is ejected through an on-off valve. Alternatively, a configuration may be adopted in which the pressure in the internal space of the cylinder tube is increased by sliding the piston using an actuator. Thus, various configurations can be adopted as the gas supply source.

A configuration may be adopted in which, as the gas compressor 18, a backflow prevention section that is configured to supply gas from a gas supply source (compressor) only into the second gas chamber 27 and allows the gas to move only in one direction from the second gas chamber 27 toward the first gas is provided, whereby the gas is compressed not only in the second gas chamber 27 but also in the first gas chamber 26. In this case, the number of gas supply paths is reduced, and simplification of the configuration can be achieved.

The agricultural material is not limited to seed N, and fertilizer, a chemical agent, or the like may be ejected.

Example embodiments of the present invention can be applied to agricultural material ejection apparatuses configured to be suspended and supported by an aircraft and to supply a granular agricultural material such as seed N or fertilizer to a supply target location.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An agricultural material ejection apparatus configured to be suspended and supported by an aircraft and to supply a granular agricultural material to a supply target location, the agricultural material ejection apparatus comprising:
a storage configured to store the agricultural material;
a feeder configured to feed the agricultural material stored in the storage; and
an ejection mechanism configured to eject the agricultural material fed by the feeder from an ejection outlet to the supply target location, the ejection mechanism including:
a gas compressor configured to compress a gas; and
a gas passage through which the compressed gas is passable from the gas compressor toward the ejection outlet; and
a temporary holder capable of temporarily holding the agricultural material from the feeder at an intermediate portion of a path of the gas passage;
the temporary holder including:
a cylindrical container including an inner passage portion through which the agricultural material is passable;
a plurality of holders provided at different positions in a circumferential direction outward of the passage portion of the container, the plurality of holders being capable of moving back and forth along directions in which the holders approach and move away from the passage portion; and
biasing elements movably biasing the plurality of holders toward waiting positions at which the holders enter the passage portion; wherein
the agricultural material fed from the feed section is capable of being received and temporarily held while the plurality of holders are at the waiting positions, and in response to the compressed gas acting to push the agricultural material, the plurality of holders move in directions away from the passage portion against a biasing force of the biasing elements to allow the agricultural material to be ejected toward the supply target location.

2. The agricultural material ejection apparatus according to claim 1, wherein the holders are located at portions spaced approximately 120 degrees apart from each other along the circumferential direction.

3. The agricultural material ejection apparatus according to claim 1, wherein the holders are spherical, and the biasing elements are coil springs.

4. The agricultural material ejection apparatus according to claim 1, wherein the gas compressor includes:
a cylinder tube;
a piston configured to slide within the cylinder tube;
a gas supply and discharge capable of switching between a supply state in which the gas is supplied into an internal space of the cylinder tube and a release state in which the internal space is opened to an outside; and
a discharger configured to discharge the gas supplied into the internal space and compressed, to the gas passage from the cylinder tube in accordance with movement of the piston.

5. The agricultural material ejection apparatus according to claim 4, further comprising:
a first gas chamber located on a first side of the piston in a sliding direction thereof inside the cylinder tube, and a second gas chamber located on a second side of the piston in the sliding direction inside the cylinder tube; and
a rod extending along the sliding direction on the first side of the piston in the sliding direction; wherein
the discharger is provided at an end portion of the cylinder tube on the first side in the sliding direction;
the rod is switchable between a closed state in which the rod closes the discharger and an open state in which the rod opens the discharger to allow the gas to be discharged, in accordance with movement of the piston;
in response to the gas supply and discharge being switched to the supply state, the rod enters the closed state, and the gas is supplied to the first gas chamber and the second gas chamber and is compressed; and
in response to the gas supply and discharge being switched to the release state, the rod switches to the open state, and the gas compressed in the first gas chamber is discharged from the discharger to an outside of the cylinder tube.
